(19) United States
(12) Patent Application Publication
(10) Pub. No.: US 2002/0069250 A1
(43) Pub. Date: Jun. 6, 2002

(54) Electronic specification change awareness method and system

(76) Inventors: Sedta Boorananut, Nonthaburi (TH); Toapong Rojanaridpiched, Bangkok (TH); Chiewcharn Sunawong, Phathumtani (TH)

Correspondence Address: Joseph A. Sawyer, Jr., SAWYER LAW GROUP LLP, P.O. Box 51418, Palo Alto, CA, 94303, US

(21) Appl. No.: 09/732,037

(22) Filed: Dec. 6, 2000

(51) Int. Cl. G06F 15/16

(52) U.S. Cl. 709/206

(57) ABSTRACT

A method and system for updating a quality system is disclosed. The quality system includes at least one specification. The method and system include receiving a change of the at least one specification of the quality system. The method and system also include automatically providing electronic notification of the change to at least one user of the quality system. The at least one user requires knowledge of the change.

### FIELD OF THE INVENTION

The present invention relates to quality systems, and more particularly to a method and system that provides notifications of changes in specifications electronically.

### BACKGROUND OF THE INVENTION

Quality systems are increasingly used by service and manufacturing organizations worldwide. Typically, the quality systems are developed to meet certain recognized standards, such as the International Standards Organization (“ISO”) quality standards. In order to implement a quality system meeting such standards, the quality system must be regulated by specifications and a documentation system. The specifications describe the organization, produce or service being provided, equipment and other requirements. The documentation provides a written record of the specifications to which others can refer.

Often, changes are made to the specifications to reflect changes that have been made in the organization, produce or service being provided, equipment and or other requirements. These changes must be reflected in the documentation for the quality system.

FIG. 1 depicts a conventional method 10 for updating the documentation for a quality system. The specification coordinator for the specification receives a conventional change notification, via step 12. Typically, the conventional change notification is a paper document received from a documentation control. The specification coordinator then completes a conventional specification change awareness record, via step 14. The conventional specification change awareness record is typically a paper document that summarizes the changes to the specification. The conventional specification change awareness record is also used to inform individuals about the change to the specification. The specification change coordinator then provides paper copies of the conventional specification change awareness record to concerned individuals within the organization, via step 16. The concerned individuals are all individuals in the organization who utilize or are involved with the changed specification and must be made aware of the change to the specification. Thus, though step 16, all concerned individuals can be made aware of the change to the specification.

However, in order to comply with standards for quality systems, merely providing the conventional specification change awareness record to all concerned individuals is not sufficient. Therefore, the recipients of the conventional specification change awareness record must acknowledge the receipt of the conventional specification change awareness record, via step 18. Typically, this is accomplished by signing off on the conventional specification change awareness record. However, a separate paper acknowledgement can be provided. Thus, in the conventional method 10, a conventional acknowledgement of the conventional specification change awareness record is merely a signed copy of the conventional specification change awareness record. The specification coordinator collects the acknowledgements from all concerned individuals, via step 20. The specification coordinator then updates the records for the specification, via step 22. Typically, step 22 includes filing copies of each of the acknowledgements from each of the concerned individuals as well as the conventional specification change awareness record. Thus, the documentation reflects the change in the specification.

Although the conventional method 10 functions, one of ordinary skill in the art will readily realize that the conventional method 10 is inefficient and time consuming. Typically, quality standards require that the method 10 be implemented in a particular amount of time. For example, the ISO requires that the method 10 be completed within seven (7) working days. The task of distributing copies of the conventional specification change awareness record and receiving the acknowledgements is time consuming. Thus, it may be difficult to comply with the deadline of seven working days. This is particularly true for large organizations which may have sites located around the world. In addition, a large amount of paper is typically required to track changes in multiple specifications. For example, a particular quality system typically has a large number of specifications which are being changed or updated on an ongoing basis. Tracking and providing the conventional specification change awareness records and acknowledgments for all of these changes require a great deal of paper and, therefore, a great deal of effort. In addition, because there may be a large number of changes to a large number of specifications, the task of disseminating the changes and collecting acknowledgements may be extremely burdensome for the specification change awareness coordinator. Thus, the conventional method is inefficient, time-consuming and inconvenient.

Accordingly, what is needed is a system and method for providing notifications of changes in quality systems more efficiently. The present invention addresses such a need.

### SUMMARY OF THE INVENTION

The present invention provides a method and system for updating a quality system. The quality system includes at least one specification. The method and system comprise receiving a change of the at least one specification of the quality system. The method and system also comprise automatically providing electronic notification of the change to at least one user of the quality system. The at least one user requires knowledge of the change.

According to the system and method disclosed herein, the present invention provides a mechanism for rapidly, easily and efficiently updating a quality system when specifications in the quality system are changed.

### BRIEF DESCRIPTION OF THE DRAWINGS

FIG. 1 is a flow chart depicting a conventional method for updating a quality system with changes to specifications.

FIG. 2 is a high level flow chart of one embodiment of a method in accordance with the present invention for updating a quality system with changes to specifications.

FIG. 3 is a block diagram of one embodiment of a system in accordance with the present invention for updating a quality system with changes to specifications as included in a network.

FIG. 4 is a more detailed flow chart of one embodiment of a method in accordance with the present invention for updating a quality system with changes to specifications.

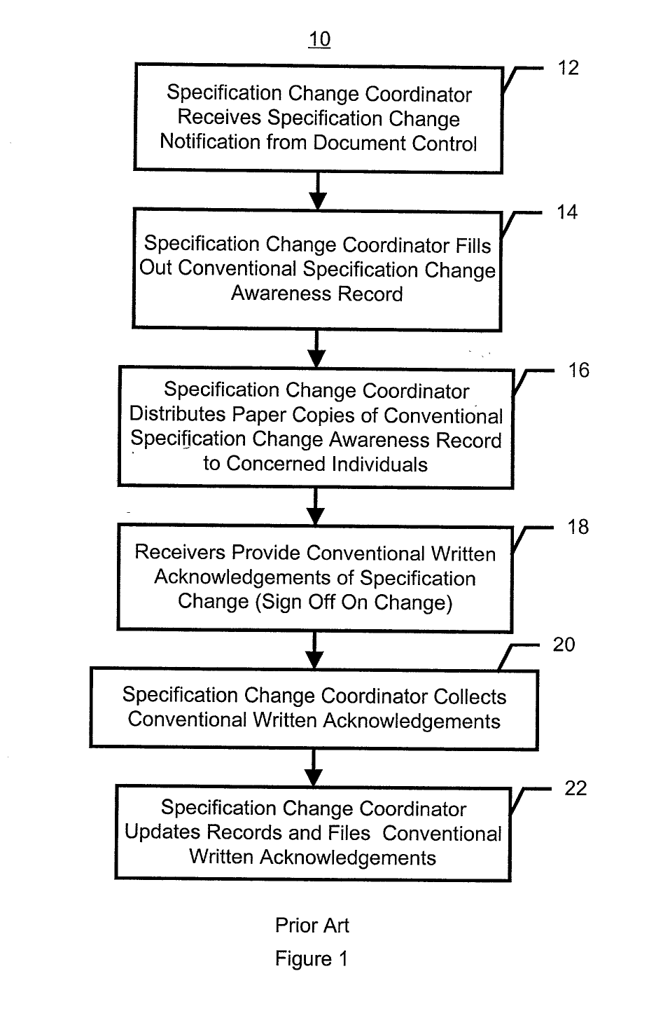

### DETAILED DESCRIPTION OF THE INVENTION

The present invention relates to an improvement in quality systems. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

Currently, quality systems are used by organizations to ensure that products and services meet certain standards. The quality systems typically include specifications describing the products or services, equipment, manufacturing methods or other aspects of the organization. The quality systems also include a documentation system that provides a record of the specification. The specifications are often changed over the course of doing business. The quality system accounts for these changes in the documentation. In addition, the quality system requires that individuals that need to be informed of the changes, called concerned individuals, are kept abreast of changes to the specifications. In order to accomplish this, conventional methods for updating the quality system utilize conventional specification change awareness records. A specification coordinator completes the conventional specification change awareness record, which describes the changes to the specifications. Paper copies of the conventional specification change awareness record are forwarded to concerned individuals, who must acknowledge receipt of the conventional specification change awareness record. The change as well as the acknowledgements must be documented within a particular amount of time. However, providing written notification of the changes and compiling the acknowledgements is relatively time consuming and inefficient and requires the use and storage of a great deal of paper. In addition, the task of disseminating the changes, collecting acknowledgements and tracking the dissemination of changes and collecting of acknowledgements may be extremely burdensome to a specification change awareness coordinator.

The present invention provides a method and system for updating a quality system. The quality system includes at least one specification. The method and system comprise receiving a change of the at least one specification of the quality system. The method and system also comprise automatically providing electronic notification of the change to at least one user of the quality system. The at least one user requires knowledge of the change.

The present invention will be described in terms of a particular method having certain steps and for certain quality control systems. However, one of ordinary skill in the art will readily recognize that this method and system will operate effectively for other systems and methods having other steps.

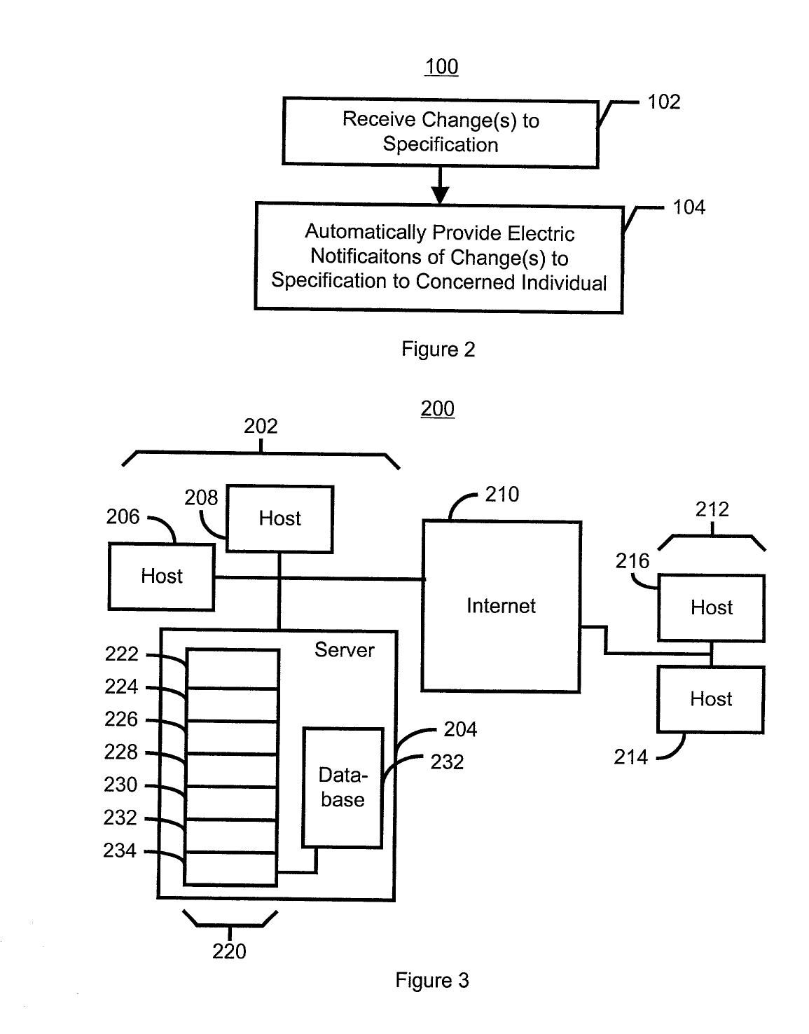

To more particularly illustrate the method and system in accordance with the present invention, refer to FIG. 2. FIG. 2 depicts a high level flow chart of one embodiment of a method 100 in accordance with the present invention for updating a quality system when changes are made to the specifications. Although the method 100 is described in the context of changes made to a single specification, nothing prevents the method 100 from being used when changes are made to multiple specifications. The change or changes for the specifications are received, via step 102. Step 102 may include a specification change awareness coordinator inputting the changes to the specification or specifications into a computer system. Concerned individuals have been automatically provided with an electronic notification of the changes, via step 104. The concerned individuals are all of those who need to be kept apprised of the change specification. The concerned individuals, for example, may include individuals who utilize the specification in the course of the duties. The concerned individuals are preferably determined automatically from the database which indicates the concerned individuals for each specification in the quality system. The electronic notification provided in step 104 is preferably an electronic specification change awareness record. The electronic specification change awareness record preferably includes a summary of the change specification. The electronic specification change awareness record is also preferably an e-mail. Therefore, all concerned individuals can be automatically notified of the change to a specification in response to the receipt of the change in the specification. This notification can be accomplished without the use of paper documents and without acquiring an individual to closely manage the notification process. Thus, the method 100 is efficient, requires little time to perform, and does not consume paper.

FIG. 3 depicts one embodiment of the specification change awareness system 220 in accordance with present invention as used in a system 200 for particular organization. The system 200 includes networks 202 and 212. The networks 202 and 212 may be physically remote from each other, coupled via the Internet 210. The network 202 includes various hosts 206 and 208, as well as a server 204, while the network 212 includes hosts 214 and 216. Note that the networks 202 and 212 can include other components. In addition, the system could include other different components and other networks coupled in a different manner. The system 200 and networks 202 and 212 are merely utilized to depict the environment in which the specification change awareness system 220 is used. The specification change awareness system 220 is depicted as residing on a server 204. However, nothing prevents the specification change awareness system from residing on the portion of the system 200. The specification change awareness system 220 preferably includes software written in Power Builder and running on an Oracle system. The specification change awareness system 220 preferably utilizes a database 240. The database 240 preferably stores information such as the specifications, concerned individuals for each of the specifications, changes that have been made to the specifications, and acknowledgments that have been received from concerned individuals for certain specifications.

The specification change awareness system 220 includes a block 222 for receiving information about changes made to the specifications and a block 224 for automatically sending electronic notifications to concerned individuals based on changes received for particular specifications. Specification change awareness system 220 also preferably includes a block 226 for determining whether acknowledgements have been received, discussed below. The specification change awareness system 220 also includes a block 228 for providing alerts when acknowledgments have not been received a particular time, a block 230 for determining whether acknowledgements have been received after a further amount of time, a block 232 for providing alerts to supervisors when required and a block 234 for storing information in the database 240. Note that although the different functions of the specification change awareness system 220 have been organized into blocks 222, 224, 226, 228, 230, 232 and 234, nothing prevents the functions of the specification change awareness system 220 from being organized in a different manner.

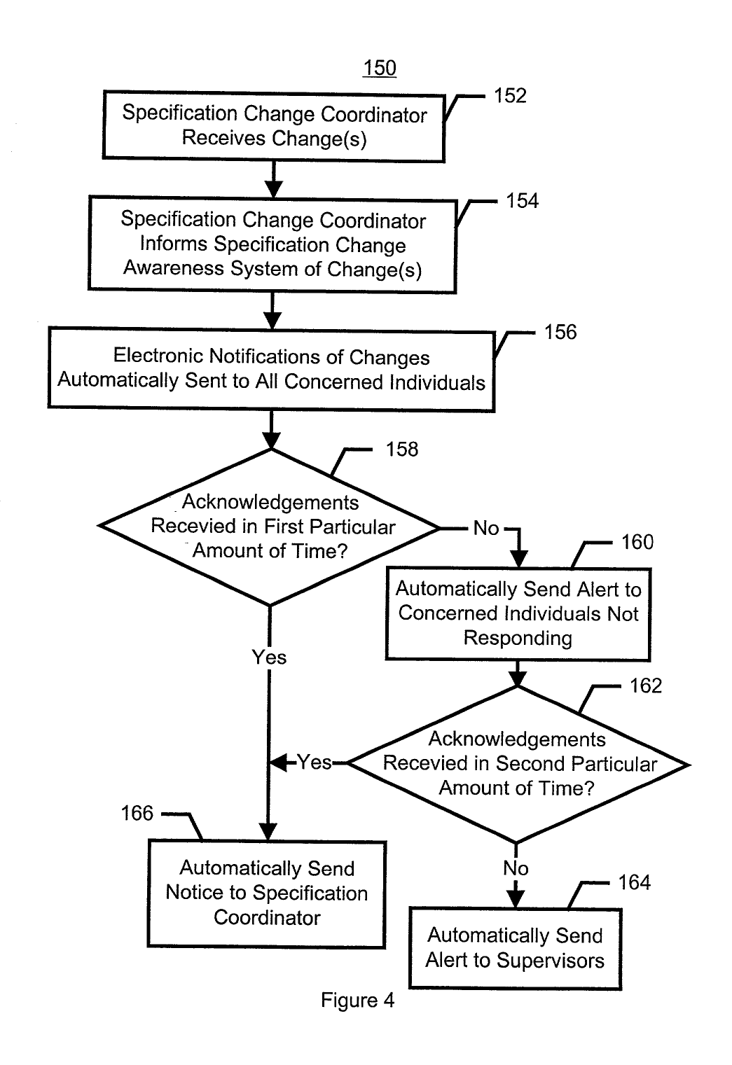

FIG. 4 depicts a more detailed flow chart of one embodiment of a method 150 in accordance with the present invention for updating a quality system when changes are made to the specifications. The method 150 will be described in conjunction with the system 200 depicted in FIG. 3. However, nothing prevents the method 150 from being used with a different system or a different specification change awareness system. Referring to FIGS. 3 and 4, the specification coordinator receives notification of changes to a specification, via step 152. Preferably, the notification of changes comes from document control. Document control is a division of the quality system which ensures that the written documentation for the quality system is maintained. The specification coordinator updates the database 240 for the specification change awareness system 220, via step 154. Preferably, the step 154 is performed by filling out an electronic specification change awareness record, via step 154. This electronic specification change awareness record may then be used update the specifications and database. However, step 154 could include the specification coordinator directly updating the specification database.

The specification change awareness system 220, preferably using block 224, automatically provides an electronic notification of the changes to specification to all concerned individuals, the step 156. Preferably, step 156 includes determining the concerned individuals and their addresses from the database 240. The electronic notification provided to the concerned individuals is preferably an e-mail. Thus, the addresses determined in step 156 are preferably e-mail addresses for the concerned individuals. The electronic notification preferably notifies concerned individuals that changes to specification have been made and provides details relating to the changes.

The specification change awareness system 220, preferably using block 226, determines whether an acknowledgment has been received from each of the concerned individuals, via step 158. Preferably step 158 is performed automatically. The acknowledgment is preferably an electronic signature for the electronic notification. Step 158 is preferably performed by collecting any acknowledgments returned from any of the concerned individuals and comparing acknowledgments received to list of the concerned individuals. Also in a preferred embodiment, step 158 determines whether these acknowledgments have been received a particular time. In one embodiment, this particular time is five days.

If not all the concerned individuals have provided an acknowledgment within the particular time, then the specification change awareness system 220, preferably using block 228, sends an alert e-mail to the concerned individuals that have not provided an acknowledgment, via step 160. In another embodiment, an alert could be provided to all concerned individuals or merely a portion of those concerned individuals who have not responded in step 160. Thus, the specification change awareness system 220 can make an extra effort to contact individuals who do not respond in a timely manner without requiring intervention of the specification change coordinator.

The specification change awareness system 220, preferably using block 230, determines whether concerned individuals that were sent an alert in step 160 provide an acknowledgment, via step 162. In step 162 this determination is preferably made within a second particular amount of time. In one embodiment, the second particular amount of time is one day. The acknowledgment preferably includes electronic signature the recipient, as discussed above. Step 162 is preferably performed by continuing to collect acknowledgements and determining whether there are any concerned individuals that have still not provided acknowledgements. If it is determined that the acknowledgment is not received in the second particular amount of time to the specification change awareness system 220, preferably using block 234, sends an alert to the supervisor of the individuals who did not provide acknowledgments, via step 164. It is then up to the individuals' supervisors to ensure that acknowledgments are provided. In another embodiment, multiple alerts may be sent to the concerned individuals and/or their supervisors. The time elements in steps 158 and 162 help to ensure that the method 150 is completed in the desired amount of time. For example, in one embodiment the method 150 should be completed within seven days.

If it is determined that acknowledgments are received in the first particular amount of time in step 158 or acknowledgments are received in the second particular amount of time after the alert in step 162, then the specification change awareness system 220 sends a notice to the specification change coordinator, via step 166. The specification coordinator can then update the written files and the database 240 to indicate not only that the specification has been changed but also that the acknowledgments have been received in the proper amount time. In another embodiment, the specification change awareness system 220 the automatically store the acknowledgments along with the changes to the specification using the storage block 234.

Therefore, to changes to the specification can be disseminated to the concerned individuals in an efficient manner. Acknowledgments can also be returned an efficient manner. Moreover, because electronic notifications and electronic acknowledgments are used large amounts of paper are not consumed. In addition, because most communication is completed electronically, the task of disseminating changes and receiving acknowledgments can be completed rapidly. Furthermore, many of these tasks are performed automatically, without the specification coordinator having to monitor each change to each specification. Because a large number of changes to large number of specifications may be made and because many tasks are performed automatically a large burden may be lifted from the specification change coordinator by the method and system in accordance with the present invention. Thus, changes to the quality system may be made and tracked more efficiently and more easily.

A method and system has been disclosed for providing an electronic change awareness system. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for updating a quality system having at least one specification, the method comprising the steps of:
(a) receiving a change of the at least one specification of the quality system; and
(b) automatically providing electronic notification of the change to at least one user of the quality system, the at least one user requiring knowledge of the change.

2. The method of claim 1 further comprising the steps of:
(c) determining whether the at least one user has acknowledged the electronic notification within a particular period of time;
(d) providing an electronic alert to the at least one user who has not acknowledged the electronic notification if the at least one user has not acknowledged the electronic notification; and
(e) providing an electronic update to a coordinator indicating that the at least one user has acknowledged the electronic notification if the at least one user has acknowledged the electronic notification.

3. The method of claim 2 further comprising the step of:
(f) providing a second electronic alert to a supervisor of the at least one user who has not acknowledged the electronic notification if the at least one user has not acknowledged the electronic notification within a second particular time after the electronic alert is sent.

4. The method of claim 1 wherein the electronic notification further includes an e-mail notification.

5. The method of claim 1 further comprising the step of:
(c) updating a database of the at least one specification to include the change prior to providing the electronic notification.

6. A method for updating a quality system having at least one specification, the method comprising the steps of:
(a) receiving a change of the at least one specification of the quality system;
(b) updating a database of the at least one specification to include the change;
(c) automatically providing electronic notification of the change to at least one user of the quality system, the at least one user requiring knowledge of the change;
(d) automatically determining whether the at least one user has acknowledged the electronic notification within a particular period of time;
(e) automatically providing an electronic alert to the at least one user who has not acknowledged the electronic notification if the at least one user has not acknowledged the electronic notification; and
(f) automatically providing an electronic update to a coordinator indicating that the at least one user has acknowledged the electronic notification if the at least one user has acknowledged the electronic notification.

7. A computer-readable medium containing a program for updating a quality system having at least one specification, the program including instructions for:
(a) allowing a change of the at least one specification of the quality system to be received; and
(b) automatically providing electronic notification of the change to at least one user of the quality system, the at least one user requiring knowledge of the change.

8. The computer-readable medium of claim 7 further comprising the steps of:
(c) determining whether the at least one user has acknowledged the electronic notification within a particular period of time;
(d) providing an electronic alert to the at least one user who has not acknowledged the electronic notification if the at least one user has not acknowledged the electronic notification; and
(e) providing an electronic update to a coordinator indicating that the at least one user has acknowledged the electronic notification if the at least one user has acknowledged the electronic notification.

9. The computer-readable medium of claim 8 further including the instructions for:
(f) providing a second electronic alert to a supervisor of the at least one user who has not acknowledged the electronic notification if the at least one user has not acknowledged the electronic notification within a second particular time after the electronic alert is sent.

10. The computer-readable medium of claims 7 wherein the electronic notification further includes an e-mail notification.

11. The computer-readable medium of claim 7 wherein the program further includes instructions for:
(c) updating a database of the at least one specification to include the change prior to providing the electronic notification.

12. A system for updating a quality system having at least one specification, the system comprising:
means for receiving a change of the at least one specification of the quality system; and
means for automatically providing electronic notification of the change to at least one user of the quality system, the at least one user requiring knowledge of the change.

13. The system of claim 12 further comprising:
means for determining whether the at least one user has acknowledged the electronic notification within a particular period of time;
means for providing an electronic alert to the at least one user who has not acknowledged the electronic notification if the at least one user has not acknowledged the electronic notification; and
means for providing an electronic update to a coordinator indicating that the at least one user has acknowledged the electronic notification if the at least one user has acknowledged the electronic notification.

14. The system of claim 12 further comprising:
means for providing a second electronic alert to a supervisor of the at least one user who has not acknowledged the electronic notification if the at least one user has not acknowledged the electronic notification within a second particular time after the electronic alert is sent.

15. The system of claim 12 wherein the electronic notification further includes an e-mail notification.

16. The system of claim 12 further comprising:
means for updating a database of the at least one specification to include the change prior to providing the electronic notification.
